(19) United States
(12) Patent Application Publication
(10) Pub. No.: US 2009/0073141 A1
(43) Pub. Date: Mar. 19, 2009

(54) ELECTRO-OPTICAL DEVICE, ELECTRONIC APPARATUS AND METHOD OF DETECTING INDICATING OBJECT

(75) Inventor: Taketo CHINO, Hokuto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/185,482

(22) Filed: Aug. 4, 2008

(30) Foreign Application Priority Data
Sep. 18, 2007 (JP) 2007-240528

(51) Int. Cl. G06F 3/042; G09G 3/36

(52) U.S. Cl. 345/175; 345/90

(57) ABSTRACT

Provided is a device for driving first and second electrodes and an electro-optical element including a material having optical characteristics that vary with an applied voltage. The device includes: a driving unit which drives the electro-optical element between first and second driving states; a display unit which displays an image based on the optical characteristics of the electro-optical element; a pickup unit that outputs image data according to the amount of incident light; a first memory which fetches/stores the image data as reference image data; a second memory which fetches/stores the image data as target image data; a difference image data generating unit which generates difference image data from a difference between the reference and target image data; and a control unit which controls the write/read of the first and second memories such that the driving states corresponding to the reference image data and the target image data become equal.

### BACKGROUND

1. Technical Field

The present invention relates to an electro-optical device including a light detecting function for specifying the position of an indicating object such as a finger and detecting an area by detecting external light, and an electronic apparatus including the electro-optical device.

2. Related Art

In an electro-optical device using liquid crystal, that is, in a liquid crystal device, if a DC voltage is applied to the liquid crystal, image quality deterioration such as burn-in is caused. Accordingly, an AC voltage is applied to the liquid crystal.

In the liquid crystal device, a plurality of pixel circuits are arranged in a matrix. In each of the pixel circuits, if a scan signal becomes a high level, a transistor is turned on and thus a data potential supplied via a data line is applied to the liquid crystal and is held in a storage capacitor. A liquid crystal element is configured by interposing the liquid crystal between a pixel electrode and a common electrode. The transistor and the pixel electrode are formed on a device substrate, and the common electrode is formed on a counter substrate. The device substrate and the counter substrate are attached to each other with a gap and the liquid crystal is injected therebetween. The common electrode formed on the counter substrate also functions as the plurality of pixel circuits and a common potential Vcom is applied thereto. In such a circuit configuration, a period in which a data potential is higher than the common potential Vcom and a period in which the data potential is lower than the common potential Vcom are alternately repeated such that the AC voltage is applied to the liquid crystal.

Meanwhile, in an electro-optical device using liquid crystal, which is widely used as a display device of an electronic apparatus, a liquid crystal device having a touch panel function, which is capable of displaying an image by light transmitting through pixel circuits and inputting information on the liquid crystal device via an indicating object such as a finger, by arranging an optical sensor in each of a predetermined number of pixel circuits, is suggested. In such a liquid crystal device, the contact of an indicating object such as a finger or an indicating member into a display surface of the liquid crystal device or the movement of the indicating object on the display surface is detected by the optical sensor such that the information on the liquid crystal device can be input. For example, in Touch Panel Function Integrated LCD Using LTPS Technology, N. Nakamura et al, IDW/AD'05 p. 1003-1006, a liquid crystal device which is capable of displaying an image by an operation of a driving circuit including a thin-film transistor (TFT) having a low temperature polysilicon (LTPS) and has a touch panel function for inputting a variety of information on the basis of an image of an indicating object acquired by the optical sensor arranged in each pixel is disclosed.

The optical sensor mounted in the liquid crystal device includes, for example, a circuit structure in which a photodiode and a capacitor are electrically connected to each other. Charges stored in the capacitor are discharged according to photoelectric current generated in the photodiode which receives incident light and the gradation level of the image is specified on the basis of a potential changed by the discharge. In more detail, for example, in a display area for displaying the image, the optical sensor arranged in an area which overlaps with the indicating object, that is, the optical sensor arranged in an area which overlaps with the shadow of the indicating object, detects the amount of incident light corresponding to the shadow of the indicating object, and the optical sensor arranged in an area which does not overlap with the indicating object detects the amount of external light which is not blocked by the indicating object as the incident light, such that an image in which the gradation levels of image portions according to a light amount difference are different is acquired. Accordingly, in such a liquid crystal device, the amount of incident light incident from the display surface for displaying the image is detected such that the position of the indicating object can be specified on the basis of the image including image portions in which the gradation levels are specified according to the amount of incident light detected by each optical sensor.

As such an electro-optical device, in JA-A-2004-318819, a technology of repeating turn-on and turn-off of a backlight in each frame and performing touch determination on the basis of difference data of an image picked up when the backlight is turned on and an image picked up when the backlight is turned off is disclosed.

However, in the case where the polarity of the liquid crystal is inverted in frame cycles, since the common potential Vcom is changed for each frame, an error occurs between the gradation of a reference image and the gradation of an image which is the object of comparison (hereinafter, referred to as a target image) due to the level change of the common potential Vcom and thus the precision of the touch determination deteriorates.

The error in the gradation due to the inversion of the polarity of the common potential Vcom occurs due to the optical adjustment such as the suppress of flicker on a liquid crystal display screen or the driving method of the liquid crystal. A variation in the offset of the potential for absorbing the difference in the common potential Vcom occurs in individual units. In more detail, an error occurs in the gradation in the case where the common potential Vcom is high or low.

### SUMMARY

An advantage of some aspects of the invention is that it provides an electro-optical device capable of determining whether or not an indicating object is approached or contacted, that is, performing a touch determination, with high precision, an electronic apparatus using the same, and a method of detecting an indicating object.

According to an aspect of the invention, there is provided an electro-optical device for driving a first electrode, a second electrode, and an electro-optical element which is provided between the first electrode and the second electrode and has an electro-optical material of which the optical characteristics are changed according to an applied voltage, the device including: a driving unit which drives the electro-optical element and switches a first driving state, in which a first fixed potential is applied to the first electrode in a state in which the electro-optical element is driven, and a data potential according to gradation to be displayed is applied to the second electrode and a second driving state, in which a second fixed potential is applied to the first electrode and the data potential is applied to the second electrode, in a predetermined cycle; a display unit which displays an image on a display screen on the basis of the optical characteristics of the electro-optical element according to the data potential; a pickup unit which is provided on the display screen and outputs image data according to the amount of incident light; a first memory which fetches and stores the image data, which is a reference of comparison, as reference image data; a second memory which fetches and stores the image data, which is an object of comparison, as target image data; a difference image data generating unit which generates a difference between the reference image data read from the first memory and the target image data read from the second memory as difference image data; and a control unit which controls the write and the read of the first memory and the second memory such that the driving state of the electro-optical element corresponding to the reference image data read from the first memory and the driving state of the electro-optical element corresponding to the target image data read from the second memory become equal.

According to the electro-optical device, the driving state of the electro-optical device when the reference image is displayed, that is, any one of the first driving state and the second driving state, and the driving state of the electro-optical material when the target image is picked up, that is, any one of the first driving state and the second driving state, are equal.

If the change of the driving state is not considered, in the touch determination using the difference data of the reference image and the target image, due to the change of the driving state, a difference or a variation occurs between the gradation of the reference image and the gradation of the target image and thus the precision of the touch determination deteriorates. In more detail, ΔV1 representing the error of the gradation of the reference image in the case where the Vcom level which is the potential of the common electrode is zero and ΔV2 representing the error of the gradation of the reference image in the case where the Vcom level which is the potential of the common electrode is 1 are different from each other, it is difficult to compare the reference image and the target image with high precision if the Vcom level which is the potential of the common electrode is not considered.

In contrast, in the present invention, since the write and the read of the first memory and the second memory are controlled such that the driving state of the electro-optical element corresponding to the reference image data read from the first memory and the driving state of the electro-optical element corresponding to the target image data read from the second memory become equal, it is possible to compare the reference image and the target image with high precision. The electro-optical material indicates a material of which the optical characteristics are changed by electric energy, such as liquid crystal.

In the electro-optical device, the control unit may store the reference image data generated when the driving state of the electro-optical element is the first driving state and the reference image data generated when the driving state of the electro-optical element is the second driving state in the first memory, store the target image data in one of the first driving state or the second driving state in the second memory, and read the target image data in one of the driving states from the second memory, supply the target image data to the difference image data generating unit, read the reference image data corresponding to one of the driving states from the first memory, and supply the reference image data to the difference image data generating unit.

In this case, the reference image data which is the reference of comparison is stored in both the first state and the second state. Accordingly, although the target image which is the object of comparison is picked up at any timing so as to generate the target image data, accurate difference image data can be generated. Since the target image is fetched at any timing, it does not need to wait for a predetermined driving state. Accordingly, the response of the touch determination can be improved.

In the electro-optical device, the control unit may store the reference image data generated in one of the first driving state or the second driving state in the first memory, store the target image data in one of the driving states in the second memory, and read the target image data in one of the driving states from the second memory, supply the target image data to the difference image data generating unit, read the reference image data corresponding to one of the driving states from the first memory, and supply the reference image data to the difference image data generating unit.

In this case, although the reference image data which is the reference of comparison is stored with respect to one of the first driving state and the second driving state, since the data is fetched in the same driving state when the target image data is stored in the second memory, it is possible to accurately generate the difference image data. In addition, since the first memory stores the reference image data in one of the driving states, it is possible to dimidiate the storage capacity compared with the case where both the first driving state and the second driving state are stored.

The electro-optical device may further include a determination unit which compares the difference image data with a predetermined level and determines whether an indicating object touches or approaches the display screen on the basis of the compared result. In this case, for example, the difference image data and the predetermined level may be compared so as to generate binary data and the touch or the approach of the indicating object may be determined on the basis of the data.

The electro-optical device may further include a determination unit which compares the difference image data with feature data representing the feature of an indicating object and determines validity of the indicating object which approaches the display screen on the basis of the compared result. In this case, if the feature data is a fingerprint, it can be used in a personal authentication. Alternatively, a QR code or a barcode used in a mobile telephone may be used

In the electro-optical device, the driving unit may switch the first driving state and the second driving states with a natural number multiple of a frame cycle or a field cycle as the predetermined cycle.

An electronic apparatus according to the invention includes any one of the electro-optical devices and the electronic apparatus includes, for example, a personal computer, a mobile telephone, a PDA, an automatic selling machine.

According to another aspect of the invention, there is provided an indicating object detecting method of detecting image data of an indicating object which approaches a display screen using an pickup unit in an electro-optical device including a first electrode, a second electrode and an electro-optical element which is provided between the first electrode and the second electrode and has an electro-optical material of which the optical characteristics are changed according to an applied voltage, a driving unit which drives the electro-optical element and switches a first driving state, in which a first fixed potential is applied to the first electrode in a state in which the electro-optical element is driven, and a data potential according to gradation to be displayed is applied to the second electrode and a second driving state, in which a second fixed potential is applied to the first electrode and the data potential is applied to the second electrode, in a predetermined cycle, a display unit which displays an image on a display screen on the basis of the optical characteristics of the electro-optical element according to the data potential, and the pickup unit which is provided on the display screen and outputs image data according to the amount of incident light, the method including: fetching the image data, which is a reference of comparison, as reference image data and storing the reference image data generated when the driving state of the electro-optical element is the first driving state and the reference image data generated when the driving state of the electro-optical element is the second driving state; fetching the image data, which is an object of comparison, and storing target image data in one of the first driving state or the second driving state; and reading the target image data in one of the driving states, reading the reference image data corresponding to one of the driving states, and generating a difference between the read reference image data and the read target image data as difference image data.

In this case, the reference image data which is the reference of comparison is stored in both the first state and the second state. Accordingly, although the target image which is the object of comparison is picked up at any timing so as to generate the target image data, accurate difference image data can be generated. Since the target image is fetched at any timing, it does not need to wait for a predetermined driving state. Accordingly, the response of the touch determination can be improved.

According to another aspect of the invention, there is an indicating object detecting method of detecting image data of an indicating object which approaches a display screen using an pickup unit in an electro-optical device including a first electrode, a second electrode and an electro-optical element which is provided between the first electrode and the second electrode and has an electro-optical material of which the optical characteristics are changed according to an applied voltage, a driving unit which drives the electro-optical element and switches a first driving state, in which a first fixed potential is applied to the first electrode in a state in which the electro-optical element is driven, and a data potential according to gradation to be displayed is applied to the second electrode and a second driving state, in which a second fixed potential is applied to the first electrode and the data potential is applied to the second electrode, in a predetermined cycle, a display unit which displays an image on a display screen on the basis of the optical characteristics of the electro-optical element according to the data potential, and the pickup unit which is provided on the display screen and outputs image data according to the amount of incident light, the method including: storing the image data, which is a reference of comparison, as reference image data in a state in which the driving state of the electro-optical element is one of the first driving state or the second driving state; storing the image data, which is an object of comparison, as target image data in a state in which the driving state of the electro-optical element is one of the driving states; and reading the target image data in one of the driving states, reading the reference image data corresponding to one of the driving states, and generating a difference between the read reference image data and the read target image data as difference image data.

In this case, although the reference image data which is the reference of comparison is stored with respect to one of the first driving state and the second driving state, since the data is fetched in the same driving state when the target image data is stored in the second memory, it is possible to accurately generate the difference image data. In addition, since the first memory stores the reference image data in one of the driving states, it is possible to dimidiate the storage capacity compared with the case where both the first driving state and the second driving state are stored.

### BRIEF DESCRIPTION OF THE DRAWINGS

The invention will be described with reference to the accompanying drawings, wherein like numbers reference like elements.

FIG. 1 is a block diagram showing the whole configuration of an electro-optical device 1 according to a first embodiment of the invention.

FIG. 2 is a circuit diagram of a pixel circuit P1(i,j) of an i^{th} row and a j^{th} column in the electro-optical device 1 according to the first embodiment of the invention.

FIG. 3 is a timing chart showing a relationship between a timing when a Vcom level is changed and a timing when an optical sensor 550 picks up an image in the case where the polarity of the potential applied to liquid crystal is inverted in frame cycles (FIG. 3A), and a relationship between a timing when the Vcom level is changed and a timing when the optical sensor 550 picks up an image in the case where the polarity of the potential applied to liquid crystal is inverted in scan line units (FIG. 3B), according to the first embodiment.

FIG. 4 is a timing chart showing an operation timing of the electro-optical device 1 according to the first embodiment of the invention.

FIG. 5 is a conceptual view illustrating the polarity of the applied voltage in a first frame period and a second period according to the first embodiment of the invention.

FIG. 6 is a flowchart illustrating an initialization process at the time of a touch determination according to the first embodiment of the invention (FIG. 6A) and a flowchart illustrating a touch determination process based on the comparison between a reference image and a target image (FIG. 6B), according to the present embodiment.

FIG. 7 is a view showing a main screen which is a detailed example of the reference image and a target image which is compared with the reference image, according to the first embodiment of the invention (FIGS. 7A and 7B), according to the first embodiment.

FIG. 8 is a view showing a fingerprint image which is previously registered as another detailed example of the reference image and a target image which is compared with the reference image in identity, according to the first embodiment.

FIG. 9 is a flowchart illustrating an initialization process at the time of touch determination according to a second embodiment of the invention (FIG. 9A) and a flowchart illustrating a touch determination process based on the comparison between a reference image and a target image (FIG. 9B), according to the second embodiment.

FIG. 10 is a perspective view showing the configuration of a personal computer which is an example of an electronic apparatus using the electro-optical device according to the present embodiment.

FIG. 11 is a perspective view showing the configuration of a mobile telephone which is an example of an electronic apparatus using the electro-optical device according to the present embodiment.

FIG. 12 is a perspective view showing the configuration of a personal digital assistant which is an example of an electronic apparatus using the electro-optical device according to the present embodiment.

### DESCRIPTION OF EXEMPLARY EMBODIMENTS

### First Embodiment

### 1. Basic Configuration

An electro-optical device according to a first embodiment of the invention uses liquid crystal as an electro-optical material. The electro-optical device 1 includes a liquid crystal panel AA (which is an example of an electro-optical panel) as a main portion. The liquid crystal panel AA is formed by attaching a device substrate, on which thin-film transistors (hereinafter, referred to as TFTs) are formed as switching elements, and a counter substrate to each other with a predetermined gap such that the electrode forming surfaces thereof face each other and filling the liquid crystal in the gap.

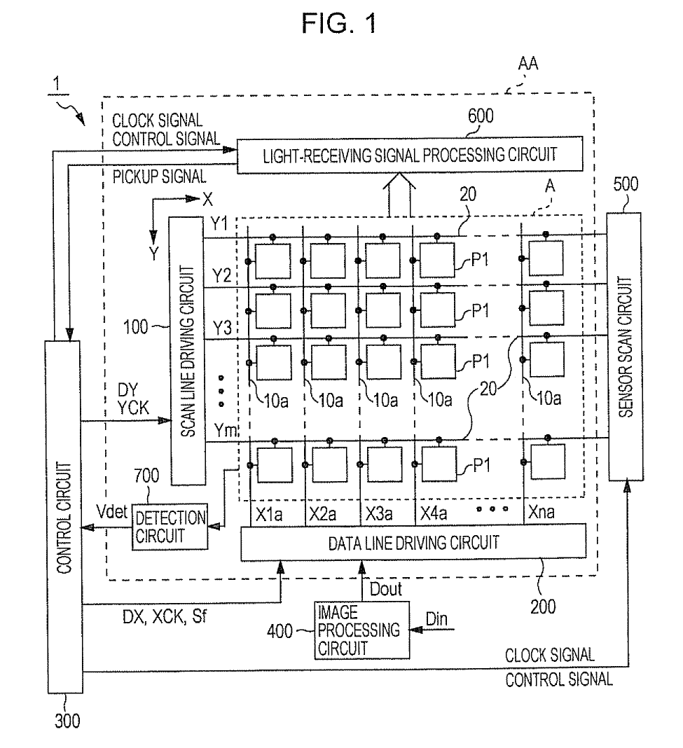

1First, the basic configuration of the electro-optical device according to the present embodiment will be described with reference to FIG. 1. FIG. 1 is a block diagram showing the overall configuration of the electro-optical device 1 according to the first embodiment.

As shown in FIG. 1, the electro-optical device 1 includes the liquid crystal panel AA, a control circuit 300, an image processing circuit 400, a sensor scan circuit 500, a light-receiving signal processing circuit 600 and a detection circuit 700. The liquid crystal panel AA is of a transmissive type, but may be a semi-transmissive type or a reflective type. The liquid crystal panel AA includes an image display area A, a scan line driving circuit 100, and a data line driving circuit 200 on the device substrate. The control circuit 300 generates and supplies an X transmission start pulse DX, an X clock signal XCK and a polarity signal Sf to the data line driving circuit 200 and generates and supplies a Y transmission start pulse DY and a Y clock signal YCK to the scan line driving circuit 100.

The polarity signal Sf shows the polarity in DC driving. In this example, the polarity of the voltage applied to the liquid crystal is inverted in frame cycles. In more detail, a common potential Vcom and a data signal are inverted in synchronization with the polarity signal Sf. The polarity signal Sf is supplied to a power source circuit (not shown) and the power source circuit generates the common potential Vcom inverted in frame cycles in synchronization with the polarity signal Sf and supplies the common potential Vcom to a common electrode formed on the counter substrate.

The detection circuit 700 detects whether the potential of the common electrode is a high level or a low level and outputs a detection signal Vdet to the control circuit 300. Since the common potential Vcom supplied to the common electrode is generated on the basis of the polarity signal Sf, the detection circuit 700 may use the polarity signal Sf instead of generating the detection signal Vdet. Since large parasitic capacitance occurs in the common electrode, it takes much time to invert the common potential Vcom although the power source circuit operates so as to invert the common potential Vcom. Accordingly, the control circuit 300 can accurately detect the state of the common potential Vcom using the detection circuit 700.

In the image display area A, a plurality of pixel circuits P1 is formed in a matrix and transmittivity of each of the pixel circuits P1 is controlled. The light from a backlight (not shown) is emitted via the pixel circuits P1. Accordingly, the gradation display due to light modulation is permitted. The image processing circuit 400 processes input image data Din and generates and outputs output image data Dout to the data line driving circuit 200.

In addition, the control circuit 300 supplies a clock signal and a sensor control signal to the sensor scan circuit 500 and supplies a clock signal and a control signal for processing a light-receiving signal to the light-receiving signal processing circuit 600.

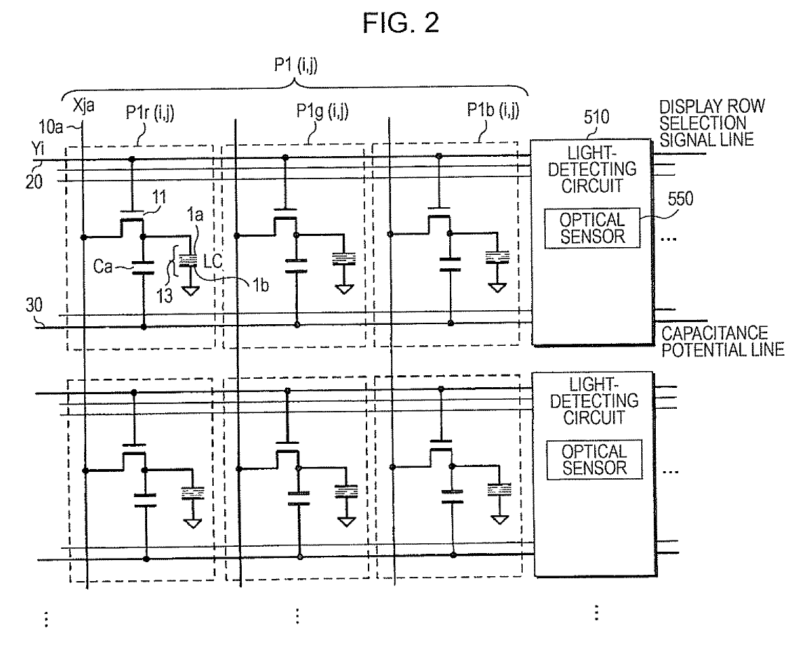

Next, the image display area A will be described in detail. In the image display area A, m (m is a natural number of 2 or more) scan lines 20 are arranged in parallel in an X direction and n (n is a natural number of 2 or more) first data lines 10a are arranged in parallel in a Y direction. In addition, a potential line for supplying a ground potential GND (see the potential line 30 of FIG. 2) is arranged in the X direction. The m×n pixel circuits P1 are arranged in intersections between the scan lines 20 and the first data lines 10a. Light-detecting circuits 510 are omitted.

First potentials X1a to Xna are supplied to the n first data lines 10a. Scan signals Y1, Y2, . . . , and Ym are line-sequentially applied to the scan lines 20 in a pulsed manner. The pixel circuit P1(i,j) of an i^{th} row (i is a natural number of 1≦i≦m) and a j^{th} column (j is a natural number of 1≦j≦n) receives a first potential Xja supplied via the first data line 10a when the scan signal Yi of the i^{th} scan line 20 is activated.

FIG. 2 is a circuit diagram of the pixel circuit P1(i,j) of the i^{th} row and the j^{th} column. Other pixel circuits P1 have the same configuration. In FIG. 2, the circuit configuration of a portion which is substantially used to display an image in the plurality of pixel portions arranged in matrix on the TFT array substrate and the light-detecting circuits 510 are shown.

As shown in FIG. 2, the plurality of pixel circuits P1(i,j) which are formed the image display area A of the electro-optical device 1 in matrix may include red pixel circuits P1r(i,j), green pixel circuits P1g(i,j) and blue pixel circuits P1b(i,j). By this configuration, the electro-optical device 1 is a display device for displaying a color image. The pixel circuits P1(i,j) are electrically connected to the light-detecting circuits 510 formed in the image display area A. The electrical connection will be described in detail later. Each of the light-detecting circuits 510 connected to the light-receiving signal processing circuit 600 includes an optical sensor 550. In particular, under the control of the control circuit 300, the light-detecting circuits 510 process the amounts of light received from a picked-up object as light-receiving signals and supplies the processed signals to the control unit as pick-up signals. The light-detecting circuits 510 correspond to the plurality of pixel circuits P1(i,j). Alternatively, the light-detecting circuits 510 correspond to the red pixel circuits P1r(i,j), the green pixel circuits P1g(i,j) and the blue pixel circuits P1b(i,j).

Each of the pixel circuits P1r(i,j), P1g(i,j) and P1b(i,j) includes a first electrode 1a, a second electrode 1b, a TFT 11, an electro-optical element 13, and a storage capacitor Ca, and an electro-optical material is interposed between the first electrode 1a and the second electrode 1b included in the electro-optical element 13. As the electro-optical material, any material of which the optical characteristics are changed according to the applied voltage may be used, but, in this example, liquid crystal LC is used. The second electrode 1b is the common electrode of the plurality of pixel circuits and the common potential Vcom is supplied thereto. In such a circuit configuration, in a period when the data potential Vdata is higher than the common potential Vcom and a period when the data potential Vdata is lower than the common potential Vcom are alternately repeated such that an AC voltage is applied to the liquid crystal LC. An example of the first electrode according to the invention is the first electrode la which is a pixel electrode. An example of the second electrode according to the invention is the second electrode 1b which is a common electrode.

In particular, the control circuit 300 detects whether the potential level Vcom of the common electrode is zero (that is, a ground level) or 1 in each frame period at a frame rate of 60 frames per second. In addition, under the control of the control circuit 300, the optical sensor 550 picks up the object, which approaches or touches the display screen, in frame cycles at a frame rate of 60 frames per second.

The TFT 11 (or the transistor 11) is electrically connected to the first electrode 1a and controls the switching of the first electrode 1a at the time of the operation of the electro-optical device 1. Each of the first data lines 10a, to which the image signals are supplied, is electrically connected to the source of the TFT 11. Image signals S1, S2, . . . written to the first data lines 10a may be line-sequentially supplied or may be supplied to groups of a plurality of adjacent first data lines 10a.

Each of the scan lines 20 is electrically connected to the gate of the TFT 11, and the electro-optical device 1 line-sequentially applies the scan signals to display row selection signal lines at predetermined timings in a pulsed manner. The first electrode la is electrically connected to the drain of the TFT 11, and each image signal supplied from each of the first data lines 10a is written at the predetermined timing by switching off the TFT 11 which is the switching element by a predetermined period. Each image signal having a predetermined level, which is written to the liquid crystal LC via the first electrode 1a, is held with the common electrode formed on the counter substrate for a predetermined period.

The liquid crystal LC inserted into the first electrode 1a modulates the light so as to realize the gradation display by changing the alignment or the order of molecule sets by the level of the applied voltage. In a normally white mode, the transmissivity of the incident light is decreased according to the voltage applied in sub pixel units and, in a normally black mode, the transmissivity of the incident light is increased according to the applied voltage in sub pixel units, such that the light having contrast according to the image signals is emitted from the electro-optical device 1. The storage capacitor Ca is provided in parallel with the liquid crystal LC formed between the first electrode 1a and the common electrode in order to prevent each image signal from being leaked. A capacitance potential line 30 is a fixed potential electrode of a pair of electrodes of the storage capacitor Ca.

### 2. Switching Timing of Driving State

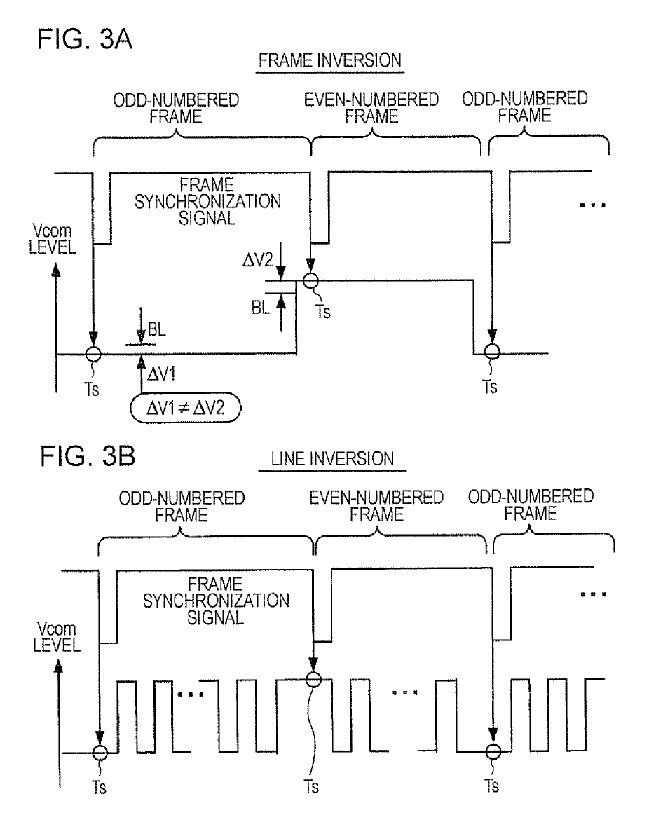

FIG. 3 is a timing chart showing a relationship between a timing when a Vcom level is changed and a timing when the optical sensor 550 picks up an image in the case where the polarity of the potential applied to the liquid crystal is inverted in frame cycles (FIG. 3A), and a relationship between a timing when the Vcom level is changed and a timing when the optical sensor 550 picks up an image in the case where the polarity of the potential applied to liquid crystal is inverted in scan line units (FIG. 3B).

As shown in FIG. 3A, in the case where the polarity of the potential applied to the liquid crystal is inverted in frame cycles, the control circuit 300 may detect whether or not the Vcom level is zero (that is, Low) in synchronization with the frame cycle. Alternatively, the control circuit 300 may detect whether or not the Vcom level is 1 (that is, High) in synchronization with the frame cycle. Accordingly, at a timing Ts when a frame synchronization signal falls, the optical sensor 550 may pick up the object which approaches or touches the display screen.

As shown in FIG. 3B, in the case where the polarity of the potential applied to the liquid crystal is inverted in scan line units, the control circuit 300 may detect whether or not the Vcom level is zero (that is, low) in synchronization with the frame cycle. Alternatively, the control circuit 300 may detect whether or not the Vcom level is 1 (that is, high) in synchronization with the frame cycle. Accordingly, at a timing Ts when a frame synchronization signal falls, the optical sensor 550 may pick up the object which approaches or touches the display screen.

In the present embodiment, the driving state of the liquid crystal at a timing when the reference image is picked up, that is, the driving state in which the Vcom level is one of zero and 1, and the driving state of the liquid crystal at a timing when the target image is picked up, that is, the driving state in which the Vcom level is one of zero and 1, are equal to each other.

If the change of the Vcom level is not considered, in a touch determination using the difference data between the reference image and the target image, a difference or a variation occurs between the gradation of the reference image and the gradation of the target image due to the change of the Vcom level and thus the precision of the touch determination deteriorates. In more detail, since ΔV1 representing the error of the gradation of the reference image in the case where the Vcom level is zero and ΔV2 representing the error of the gradation of the reference image in the case where the Vcom level is 1 are different from each other, it is difficult to compare the reference image and the target image with high precision if the Vcom level is not considered.

In contrast, in the present embodiment, the driving state of the liquid crystal at the timing when the reference image is picked up, that is, the driving state in which the Vcom level is one of zero and 1, and the driving state of the liquid crystal at the timing when the target image is picked up, that is, the driving state in which the Vcom level is one of zero and 1, are equal to each other. Accordingly, since the gradation difference of the image is not substantially or completely influenced by different driving states of the liquid crystal, it is possible to compare the reference image and the target image with high precision. In more detail, the reference image and the target image is compared on the basis of the difference data detected by the comparison between the reference image and the target image such that the difference between the reference image and the target image is identified with high precision and the determination whether or not the indicating object is approached or contacted, that is, the touch determination, can be performed with high precision.

### 2-1. Various Methods of Switching Driving State

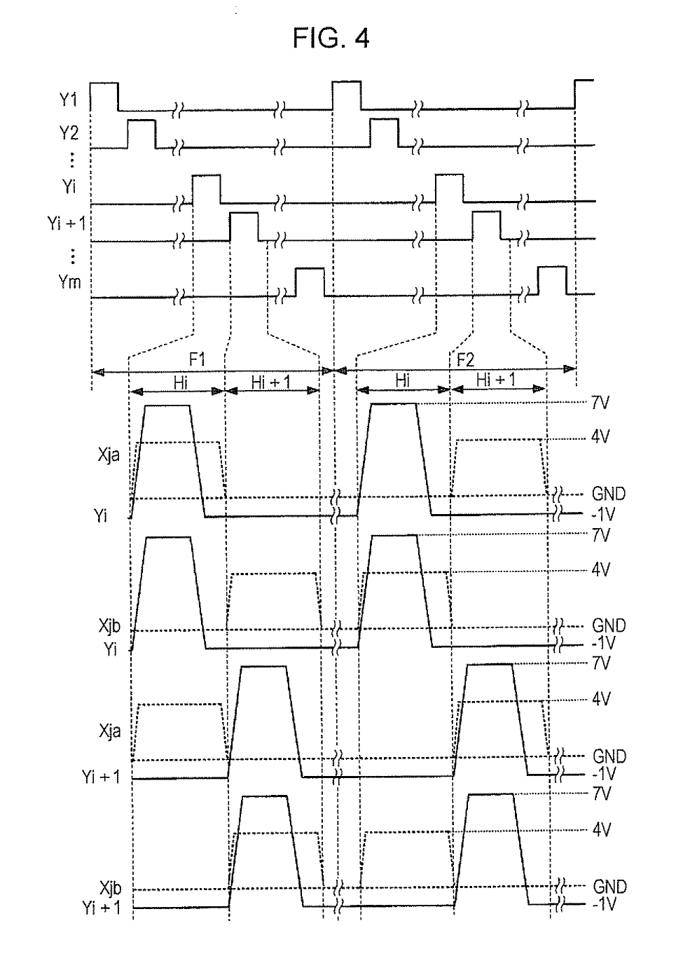

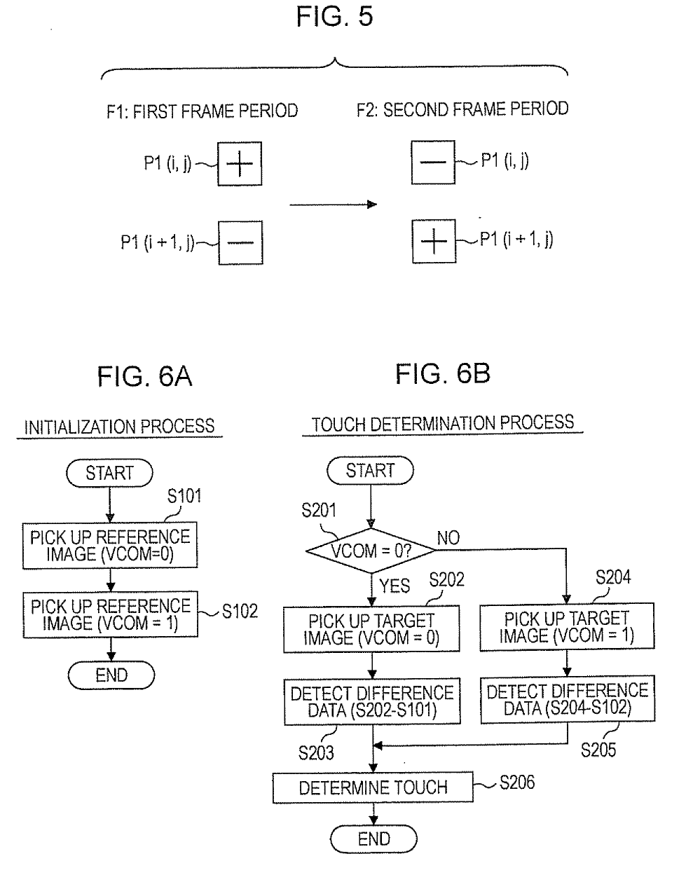

Now, various methods of switching the driving state of the liquid crystal according to the present embodiment will be described. FIG. 4 is a timing chart showing an operation timing of the electro-optical device 1 according to the first embodiment of the invention. FIG. 5 is a conceptual view illustrating the polarity of the applied voltage in a first frame period and a second period according to the present embodiment.

As shown in FIG. 4, in an i^{th} horizontal scan period Hi of the first frame period F1 (that is, the period of the first driving state), the scan signal Yi is activated. Then, the transistor 11 of the pixel circuit P1(i,j) is turned on, the first potential Xja is applied to the first electrode 1a, and the second electrode 1b becomes a ground potential GND. In other words, the first potential Xja becomes the data potential Vdata according to the gradation to be displayed and the second potential Xjb becomes the ground potential GND (fixed potential). The potential according to the gradation is held by the storage capacitor Ca. As a result, in the first frame period F1, the potential of the first electrode 1a is higher than the ground potential GND of the second electrode 1b.

Even in an i^{th} horizontal scan period Hi of the second frame period F2 (that is, the period of the second driving state), the transistor 11 of the pixel circuit P1(i,j) is turned on, the first electrode 1a becomes the ground potential GND and the first potential Xja is applied to the second electrode 1b. The relationship between the first electrode 1a and the second electrode 1b in the second frame period F2 is opposite to that in the first frame period F1. That is, in the second frame period F2, the potential of the first electrode 1a becomes the ground potential GND and the potential of the second electrode 1b becomes the data potential Vdata. Accordingly, in the second frame period F2, the potential of the second electrode 1b is higher than the ground potential GND of the first electrode 1a.

In the first frame period F1 and the second frame period F2, the direction of the voltage applied to the electro-optical device 13 is inverted such that the AC voltage is applied to the liquid crystal LC. In the AC driving method, there are various methods as follows. In the following description, the polarity of the voltage applied to the liquid crystal LC is called a positive polarity if the potential of the first electrode 1a is higher than that of the second electrode 1b and is called a negative polarity if the potential of the first electrode 1a is lower than that of the second electrode 1b.

A V inversion method is an inversion method in which a high potential is supplied to all the first electrodes la and the ground potential GND is supplied to the second electrode 1b in any frame (vertical scan) period and then the ground potential GND is supplied to all the first electrodes 1a and the high potential is supplied to the second electrode 1b in a next frame period. In the v inversion method, the polarity of the voltage applied to the liquid crystal LC in all the pixel circuits P1 is common and thus the polarity of the applied voltage is inverted between adjacent frames.

In an S inversion method, the high potential and the ground potential GND are alternately supplied to the first electrodes 1a for each data line (each column) such that the polarity of the voltage applied to the liquid crystal LC is inverted for each column, in any frame period. Then, in a next frame period, the ground potential GND is supplied to the first electrodes 1a to which the high potential is supplied in the previous frame period and the high potential is supplied to the first electrodes 1a to which the ground potential GND is supplied. In the S inversion method, the polarity of the voltage applied to the liquid crystal LC is inverted for each column and the polarity of the voltage applied to the liquid crystal LC is inverted between adjacent frames.

In an H inversion method, the high potential and the ground potential GND are alternately supplied to the first electrodes 1a for each scan line (each row) such that the polarity of the voltage applied to the liquid crystal LC is inverted for each column, in any frame period. Then, in a next frame period, the ground potential GND is supplied to the first electrodes 1a to which the high potential is supplied in the previous frame period and the high potential is supplied to the first electrodes 1a to which the ground potential GND is supplied. In the H inversion method, the polarity of the voltage applied to the liquid crystal LC is inverted for each row and the polarity of the voltage applied to the liquid crystal LC is inverted between adjacent frames.

A dot inversion method is a combination of the S inversion method and the H inversion method. In the dot inversion method, the high potential and the ground potential GND are alternately supplied to the first electrodes 1a for each scan line and data line (that is, for each pixel unit) such that the polarity of the voltage applied to the liquid crystal LC is inverted for each row and column, in any frame period. Then, in a next frame period, the ground potential GND is supplied to the first electrodes 1a to which the high potential is supplied in the previous frame period and the high potential is supplied to the first electrodes 1a to which the ground potential GND is supplied. In the dot inversion method, the polarity of the voltage applied to the liquid crystal LC is inverted for each row and column, and the polarity of the voltage applied to the liquid crystal LC is inverted between adjacent frames.

Although the electro-optical device 1 according to the present embodiment may employ any one of the various methods, if the S inversion method is employed, as shown in FIG. 4, in the i^{th} horizontal scan period Hi of the first frame period F1, in the pixel circuit P1(i,j), the data potential Vdata is supplied to the first electrode 1a and the ground potential GND is supplied to the second electrode 1b. Accordingly, in the first frame period F1, the polarity of the voltage applied to the liquid crystal LC of the pixel circuit P1(i,j) becomes the positive polarity. Next, in the i+1^{th} horizontal scan period Hi+1 of the first frame period F1, in the pixel circuit P1(i+1,j), the data potential Vdata is supplied to the second electrode 1b and the ground potential GND is supplied to the first electrode 1a. Accordingly, in the first frame period F1, the polarity of the voltage applied to the liquid crystal LC of the pixel circuit P1(i+1,j) becomes the negative polarity.

In the i^{th} horizontal scan period Hi of the second frame period F2, in the pixel circuit P1(i,j), the data potential Vdata is supplied to the second electrode 1b and the ground potential GND is supplied to the first electrode 1a. Accordingly, in the second frame period F2, the polarity of the voltage applied to the liquid crystal LC of the pixel circuit P1(i,j) becomes the negative polarity. Next, in the i+1^{th} horizontal scan period Hi+1 of the second frame period F2, in the pixel circuit P1(i+1,j), the data potential Vdata is supplied to the first electrode 1a and the ground potential GND is supplied to the second electrode 1b. Accordingly, in the second frame period F2, the polarity of the voltage applied to the liquid crystal LC of the pixel circuit P1(i+1,j) becomes the positive polarity.

As a result, as shown in FIG. 5, in the first frame period F1 and the second frame period F2, the polarities of the voltages applied to the liquid crystal LC of the pixel circuit P1(i,j) and the liquid crystal LC of the pixel circuit P1(i+1,j) are inverted and the polarities of the voltages applied to the liquid crystal LC of the pixel circuit P1(i,j) and the liquid crystal LC of the pixel circuit P1(i+1,j) are inverted between the frames.

### 3. Operation Principle

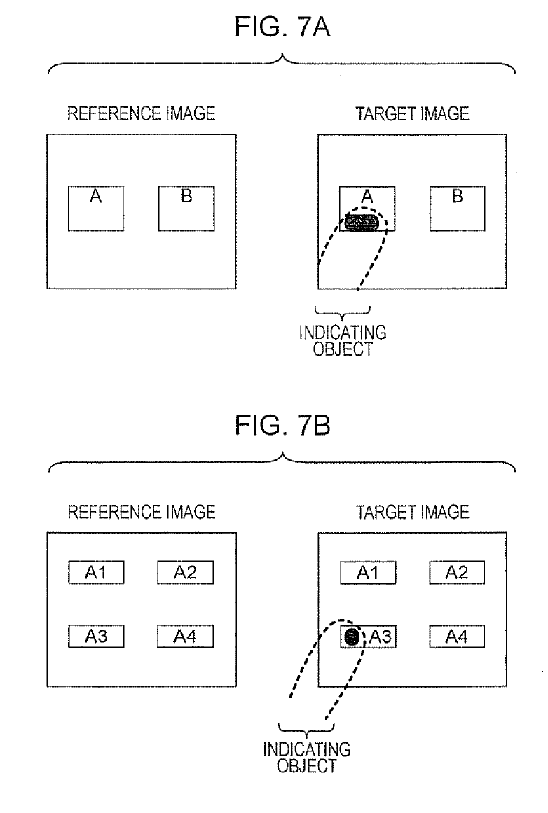

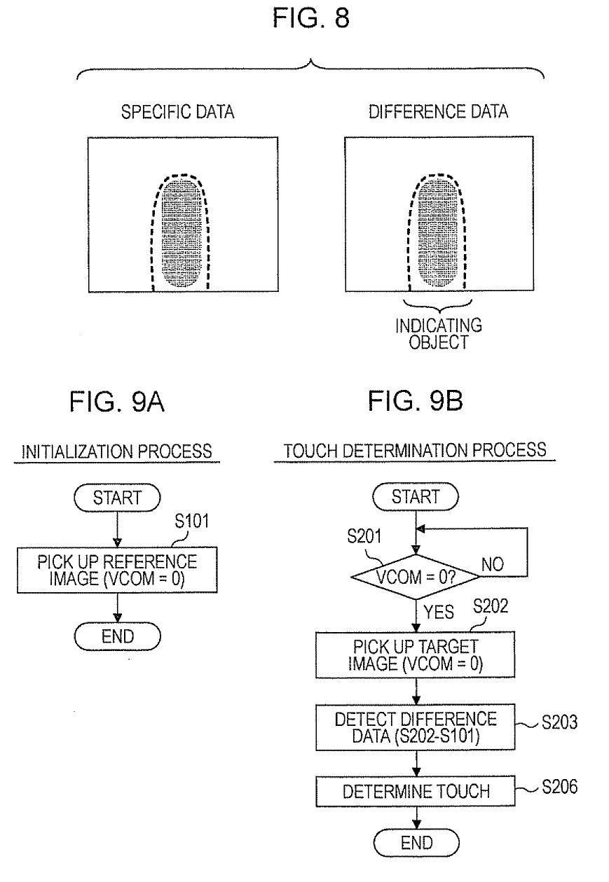

Next, a touch determination process based on the comparison between the reference image and the target image according to the present embodiment will be described with reference to FIGS. 6 to 8. FIG. 6 is a flowchart illustrating an initialization process at the time of the touch determination according to the first embodiment of the invention (FIG. 6A) and a flowchart illustrating the touch determination process based on the comparison between the reference image and the target image (FIG. 6B), according to the present embodiment. FIG. 7 is a view showing a main screen which is a detailed example of the reference image and the target image which is compared with the reference image, according to the first embodiment of the invention (FIGS. 7A and 7B). FIG. 8 is a view showing a fingerprint image which is previously registered as another detailed example of the reference image and a target image which is compared with the reference image in identity. In the present embodiment, the low potential (first fixed potential) or the high potential (second fixed potential) is supplied as the common potential Vcom of the common electrode. In more detail, the common potential Vcom becomes the low potential (=0) in an odd-numbered frame and the common potential Vcom becomes the high potential (=1) in an even-numbered frame.

First, as shown in FIG. 6A, as the initialization process, under the control of the control circuit 300, for example, in the odd-numbered frame at a frame rate of 60 frames per second, at a timing when the ground potential GND is supplied to the second electrode 1b which is the common electrode, the Vcom level which is the potential level of the common electrode becomes the low potential (that is, the ground level), and the data potential is applied to the first electrode 1a which is the pixel electrode, the reference image is picked up by the optical sensor 550 (step S101). The reference image is transmitted to the control circuit 300 as first reference image data and is stored in a first memory provided in the control circuit 300. This reference image indicates an image which becomes a reference of comparison, for example, an image which becomes a reference of comparison for identifying the change of the picked-up image in the case where an indication determination process or a fingerprint authentication process using the indicating object in an optical touch panel is performed.

Next, under the control of the control circuit 300, for example, in an even-numbered frame at a frame rate of 60 frames per second, at a timing when the Vcom level which is the potential level of the common electrode becomes the high potential, the reference image is picked up by the optical sensor 550 (step S102). This reference image is transmitted to the control circuit 300 as second reference image data and is stored in the first memory provided in the control circuit 300.

In particular, the picking-up of the reference image in frame cycles as the initialization process may be performed when power is applied to the liquid crystal panel or when a button for the initialization process is operated by a user. The picking-up of the reference image may be performed when the display image is switched or periodically at a predetermined time interval.

Subsequently, as shown in FIG. 6B, as the touch determination process, under the control of the control circuit 300, the ground potential GND is supplied to the common electrode and it is determined whether or not the Vcom level which is the potential level of the common electrode is zero (that is, the ground level) (step S201). If it is determined that the Vcom level which is the potential level of the common electrode is zero (step S201: Yes), under the control of the control circuit 300, for example, in the odd-numbered frame at a frame rate of 60 frames per second, the ground potential GND is supplied to the common electrode, the Vcom level which is the potential level of the common electrode becomes zero (that is, the ground level, and, at a timing when the data potential is applied to the pixel electrode, the target image is picked up by the optical sensor 550 (step S202). In more detail, one screen of the display screen is picked up by the optical sensor 550. The target image is transmitted to the control circuit 300 as target image data and is stored in a second memory provided in the control circuit 300. The target image indicates an image which is the object of comparison, for example, an image which is the object of comparison for identifying the change of the picked-up image in the case where an indication determination process or a fingerprint authentication process using the indicating object in an optical touch panel is performed.

Next, under the control of the control circuit 300, the first reference image data picked up in the step S101 is read from the first memory, a difference of the target image data representing the target image picked up in the step S202 is calculated, and difference data is detected (step S203). Since the target image data is fetched in the odd-numbered frame, the first reference image data and the target image data which is the object of comparison are generated in a state in which the common potential Vcom is the low potential. Accordingly, the difference data shows the change of the gradation with high precision.

In contrast, it is determined that the Vcom level which is the potential level of the common electrode is not zero in the step S201, that is, it is determined that the Vcom level is 1 (step S201: NO), under the control of the control circuit 300, for example, in the even-numbered frame at a frame rate of 60 frames per second, at a timing when the Vcom level which is the potential level of the common electrode becomes 1, the target image is picked up by the optical sensor 550 (step S204). The target image is transmitted to the control circuit 300 as target image data and is stored in the second memory provided in the control circuit 300.

Next, under the control of the control circuit 300, a difference between the second reference image data representing the reference image picked up in the step S102 and the target image data picked up in the step S204 is calculated and difference data is detected (step S205). Since the target image data is fetched in the even-numbered frame, the first reference image data and the target image data which is the object of comparison are generated in a state in which the common potential Vcom is the high potential. Accordingly, the difference data shows the change of the gradation with high precision.

Next, under the control of the control circuit 300, in the step S203 or the step S205, the detected difference data is compared with a predetermined level and the determination whether or not the indicating object approaches or touches the display screen, that is, the touch determination, is performed on the basis of the compared result (step S206).

In more detail, if the detected difference data is larger than an allowable error range of the optical sensor 550, it can be determined that the amount of incident light is significantly changed and thus it can be determined that the indicating object is approached or touched. Alternatively, in more detail, if the detected difference data is smaller than an allowable error range of the optical sensor 550, it can be determined that the amount of incident light is hardly changed and thus it can be determined that the indicating object is not approached or touched.

For example, as shown at the left side of FIG. 7A, the reference image representing images of a button “A” and a button “B” and the target image picked up by the optical sensor 550 when projecting the shadow of the indicating object such as the finger of a person onto the reference image are compared. As the result of comparison, if the difference data between the detected reference image and the target image is larger than the allowable error range of the optical sensor 550, it can be determined that the amount of incident light is significantly changed due to the shadow of the finger of the person and thus it can be determined that the finger of the person is approached or touched. By the touch determination of the finger of the person, the screen proceeds to a next menu screen and, as shown at the left side of FIG. 7B, the reference image representing the images of buttons “A1”, “A2” and “A3” and a button “A4” is displayed on the display screen. The reference image and the target image obtained when the finger of the person is approached and the shadow of the finger of the person is projected are compared similar to the above method.

In a step S206, the difference data detected in the step S203 or the step S205 and feature data representing the feature of the indicating object are compared and the validity of the indicating object approaching the display screen is identified. In more detail, the image of the fingerprint shown at the left side of FIG. 8 is previously registered as the feature data and an identification determination whether or not the difference data shown at the right side of FIG. 8 is equal, that is, a fingerprint authentication, can be performed.

In particular, in the present embodiment, since the driving state of the liquid crystal at the timing when the reference image is picked up and the driving state of the liquid crystal at the timing when the target image is picked up are equal, the gradation difference of the image is not substantially or completely influenced by the difference in the driving state of the liquid crystal and thus the reference image and the target image can be compared with high precision. In more detail, on the basis of the difference data detected by the comparison between the reference image and the target image, the reference image and the target image are compared, the difference between the both images is identified with high precision, and the determination whether or not the indicating object is touched, that is, the touch determination, can be performed with high precision. Alternatively, on the basis of the difference data detected by the comparison between the reference image and the target image, the reference image and the target image are compared, the identity thereof is identified with high precision, and the fingerprint authentication can be performed with high precision.

### 4. Second Embodiment

Next, an electro-optical device according to a second embodiment will be described with reference to FIG. 9. The configuration of the electro-optical device according to the second embodiment is equal to that of the electro-optical device according to the first embodiment described with reference to FIGS. 1 to 8. FIG. 9 is a flowchart illustrating an initialization process at the time of touch determination according to the second embodiment of the invention (FIG. 9A) and a flowchart illustrating a touch determination process based on the comparison between a reference image and a target image (FIG. 9B), according to the second embodiment.

First, as shown in FIG. 9A, as the initialization process, under the control of the control circuit 300, for example, in the odd-numbered frame at a frame rate of 60 frames per second, at a timing when the ground potential GND is supplied to the second electrode 1b which is the common electrode, the Vcom level which is the potential level of the common electrode becomes the low potential (that is, the ground level), and the data potential is applied to the first electrode 1a which is the pixel electrode, the reference image is picked up by the optical sensor 550 (step S101). That is, the reference image data is generated in a state in which the common potential Vcom is the low potential and is stored in the first memory of the control circuit 300.

Subsequently, as shown in FIG. 9B, as the touch determination process, under the control of the control circuit 300, the ground potential GND is supplied to the common electrode and it is determined whether or not the Vcom level which is the potential level of the common electrode is zero (that is, the ground level) (step S201) and the determination is repeated until the common potential Vcom becomes the low potential (=0). Then, if the common potential Vcom becomes the low potential (step S201: Yes), the target image is picked up by the optical sensor 550 (step S202). In more detail, one screen of the display screen is picked up by the optical sensor 550 and target image data representing the picked-up target image is stored in the second memory of the control circuit 300.

Next, under the control of the control circuit 300, the reference image data representing the reference image picked up in the step S101 and the target image data representing the target image picked up in the step S202 are read from the first memory and the second memory, the difference therebetween is calculated, and the difference data is detected (step S203). Since the target image data is fetched in the odd-numbered frame, the reference image data and the target image data which is the object of comparison are generated in a state in which the common potential Vcom is the low potential. Accordingly, the difference data shows the change of the gradation with high precision.

Next, under the control of the control circuit 300, on the basis of the difference data detected in the step S203, the reference image and the target image are compared, the difference between the both images is identified, and the determination whether or not the indicating object is touched, that is, the touch determination, is performed (step S206).

According to the electro-optical device of the second embodiment, since the reference image data is stored in the first memory in a state in which the common potential Vcom is the low potential, the reference image data does not need to be stored in a state in which the common potential Vcom is the high potential. Accordingly, it is possible to dimidiate the storage capacity of the first memory compared with the first embodiment. Although, in the present embodiment, the reference image and the target image are compared in the odd-numbered frame, the reference image and the target image may be compared in the even-numbered frame. In other words, the control circuit 300 stores the reference image data generated in a driving state in which the common potential Vcom is the high potential or the low potential in the first memory, stores the target image data generated in one driving state in the second memory, and generates the difference data on the basis of the data.

### 5. Electronic Apparatus

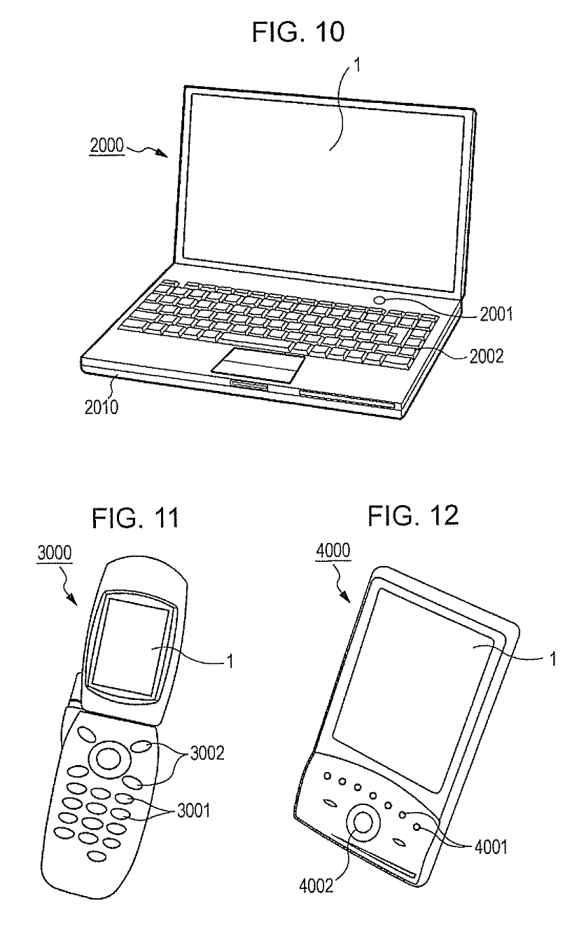

Next, an electronic apparatus using the electro-optical device 1 according to the above-described embodiment will be described. FIG. 10 shows the configuration of a mobile personal computer using the electro-optical device 1. The personal computer 2000 includes the electro-optical device 1 as a display unit and a main body 2010. The main body 2010 includes a power switch 2001 and a keyboard 2002.

FIG. 11 shows the configuration of a mobile telephone using the electro-optical device 1. The mobile telephone 3000 includes a plurality of operation buttons 3001, a scroll button 3002 and the electro-optical device 1 as a display unit. By operating the scroll button 3002, the screen displayed on the electro-optical device 1 is scrolled.

FIG. 12 shows the configuration of a personal digital assistant (PDA) using the electro-optical device 1. The PDA 4000 includes a plurality of operation buttons 4001, a power switch 4002 and the electro-optical device 1 as a display unit. When the plurality of operation buttons 4001 are operated, a variety of information such as an address book or a schedule book is displayed on the electro-optical device 1.

As the electronic apparatus using the electro-optical device 1, in addition to those shown in FIGS. 10 to 12, there are a digital still camera, a liquid crystal television set, a viewfinder-type or direct-view monitor type video tape recorder, a car navigation system, a pager, an electronic organizer, an electronic calculator, a word processor, a workstation, a videophone, a POS terminal, and a touch-panel-equipped device. The above-described electro-optical device 1 is applicable as the display units of the electronic devices.

The entire disclosure of Japanese Patent Application No. 2007-240528, filed Sep. 18, 2007 is expressly incorporated by reference herein.

What is claimed is:

1. An electro-optical device for driving an electro-optical element including a first electrode, a second electrode, and an electro-optical material provided between the first electrode and the second electrode, optical characteristics of the electro-optical material being changed according to an applied voltage, the device comprising:
a driving unit which drives the electro-optical element and switches a driving state of the electro-optical element in a predetermined cycle, between:
a first driving state in which a first fixed potential is applied to the first electrode and a data potential according to gradation to be displayed is applied to the second electrode; and
a second driving state in which a second fixed potential is applied to the first electrode and the data potential is applied to the second electrode;
a display unit which displays an image on a display screen on the basis of the optical characteristics of the electro-optical element according to the data potential;
a pickup unit which is provided on the display screen and outputs image data according to the amount of incident light;
a first memory which fetches a portion of the image data to be used as a reference of comparison, and stores the portion as reference image data;
a second memory which fetches a portion of the image data to be used as an object of comparison, and stores the portion as target image data;
a difference image data generating unit which generates a difference between the reference image data read from the first memory and the target image data read from the second memory as difference image data; and
a control unit which controls the write and the read of the first memory and the second memory such that 1) the driving state of the electro-optical element corresponding to the reference image data read from the first memory and 2) the driving state of the electro-optical element corresponding to the target image data read from the second memory become equal.

2. The electro-optical device according to claim 1, wherein the control unit:
stores the reference image data generated when the driving state of the electro-optical element is the first driving state and the reference image data generated when the driving state of the electro-optical element is the second driving state in the first memory,
stores the target image data in one of the first driving state or the second driving state in the second memory, and
reads the target image data in one of the driving states from the second memory, supplies the target image data to the difference image data generating unit, reads the reference image data corresponding to one of the driving states from the first memory, and supplies the reference image data to the difference image data generating unit.

3. The electro-optical device according to claim 1, wherein the control unit:
stores the reference image data generated in one of the first driving state or the second driving state in the first memory,
stores the target image data in one of the driving states in the second memory, and
reads the target image data in one of the driving states from the second memory, supplies the target image data to the difference image data generating unit, reads the reference image data corresponding to one of the driving states from the first memory, and supplies the reference image data to the difference image data generating unit.

4. The electro-optical device according to claim 1, further comprising a determination unit which compares the difference image data with a predetermined level and determines whether an indicating object touches or approaches the display screen on the basis of the compared result.

5. The electro-optical device according to claim 1, further comprising a determination unit which compares the difference image data with feature data representing the feature of an indicating object and determines validity of the indicating object which approaches the display screen on the basis of the compared result.

6. The electro-optical device according to claim 1, wherein the driving unit switches the first driving state and the second driving states with a natural number multiple of a frame cycle or a field cycle as the predetermined cycle.

7. An electronic apparatus comprising the electro-optical device according to claim 1.

8. An indicating object detecting method of detecting image data of an indicating object which approaches a display screen using an pickup unit in an electro-optical device including an electro-optical element including a first electrode, a second electrode and an electro-optical material provided between the first electrode and the second electrode, optical characteristics of the electro-optical material being changed according to an applied voltage, a driving unit which drives the electro-optical element and switches a driving state of the electro-optical element in a predetermined cycle, between:
a first driving state in which a first fixed potential is applied to the first electrode and a data potential according to gradation to be displayed is applied to the second electrode; and
a second driving state in which a second fixed potential is applied to the first electrode and the data potential is applied to the second electrode, a display unit which displays an image on a display screen on the basis of the optical characteristics of the electro-optical element according to the data potential, and the pickup unit which is provided on the display screen and outputs image data according to the amount of incident light, the method comprising:
fetching the image data, which is a reference of comparison, as reference image data and storing the reference image data generated when the driving state of the electro-optical element is the first driving state and the reference image data generated when the driving state of the electro-optical element is the second driving state;
fetching the image data, which is an object of comparison, and storing target image data in one of the first driving state or the second driving state; and
reading the target image data in one of the driving states, reading the reference image data corresponding to one of the driving states, and generating a difference between the read reference image data and the read target image data as difference image data.

9. An indicating object detecting method of detecting image data of an indicating object which approaches a display screen using an pickup unit in an electro-optical device including an electro-optical element including a first electrode, a second electrode and an electro-optical material provided between the first electrode and the second electrode, optical characteristics of the electro-optical material being changed according to an applied voltage, a driving unit which drives the electro-optical element and switches a driving state of the electro-optical element in a predetermined cycle, between:
a first driving state in which a first fixed potential is applied to the first electrode and a data potential according to gradation to be displayed is applied to the second electrode; and
a second driving state in which a second fixed potential is applied to the first electrode and the data potential is applied to the second electrode, a display unit which displays an image on a display screen on the basis of the optical characteristics of the electro-optical element according to the data potential, and the pickup unit which is provided on the display screen and outputs image data according to the amount of incident light, the method comprising:
storing the image data, which is a reference of comparison, as reference image data in a state in which the driving state of the electro-optical element is one of the first driving state or the second driving state;
storing the image data, which is an object of comparison, as target image data in a state in which the driving state of the electro-optical element is one of the driving states; and
reading the target image data in one of the driving states, reading the reference image data corresponding to one of the driving states, and generating a difference between the read reference image data and the read target image data as difference image data.
